(19) United States
(12) Patent Application Publication
(10) Pub. No.: US 2016/0005524 A1
(43) Pub. Date: Jan. 7, 2016

(54) IMMERSION COOLED TOROID INDUCTOR ASSEMBLY

(71) Applicant: Hamilton Sundstrand Corporation, Charlotte, NC (US)

(72) Inventor: Robert Scott Downing, Rockford, IL (US)

(21) Appl. No.: 14/324,984

(22) Filed: Jul. 7, 2014

(51) Int. Cl. H01F 27/18

(52) U.S. Cl. CPC H01F 27/18

(57) ABSTRACT

An inductor assembly includes a substrate that is configured to circulate coolant; an outer cylindrical housing arranged on the substrate and defining an internal cavity; a wound inductor core arranged in internal cavity; a condenser arranged between the wound inductor core and the substrate; and a working fluid disposed in the internal cavity and in contact with each of the inductor core and the condenser. The condenser is configured to condense vaporized working fluid as it traverses through the condenser.

### FIELD OF THE INVENTION

The subject matter disclosed herein relates to the field of inductor assemblies, and to cooling features in immersion-cooled toroid inductor assemblies.

### DESCRIPTION OF RELATED ART

Conventionally, a toroid inductor assembly includes conductive wires wrapped about a toroid inductive core. The conductive wires can be held in place with a potting compound or by retention in a plastic or thermoplastic bobbin. Frequently, the selected magnetic core material has to operate at a temperature of 150 degree Celsius (302 degree Fahrenheit) or lower in the inductor assembly. However, the inductive cores have an operating temperature limit much lower than that of most conventional conductive wires, and therefore, limit the ability for conventional potted inductor assemblies to be used in some hot environments. The toroid cores are typically mounted to a cold plate. Cooling the toroid cores relies on conduction of the heat axially from the core to the coldplate through the wires, the potting and the core. The temperature drop associated with the conduction of heat is large for high power inductor assemblies and, so, there is a need to provide better cooling of the inductor assembly for operation in hotter environments.

### BRIEF SUMMARY

According to an aspect of the invention, an inductor assembly includes a substrate that is configured to circulate a coolant; an outer cylindrical housing arranged on the substrate and defining an internal cavity; a wound inductor core arranged in internal cavity; a condenser arranged between the wound inductor core and the substrate; and a working fluid disposed in the internal cavity and in contact with each of the inductor core and the condenser. The condenser is configured to condense vaporized working fluid as it traverses through the condenser.

In addition to one or more of the features described above, or as an alternative, further embodiments could include a plate-fin condenser with an array of radial strip fins that is configured to decrease a flow area of the condenser from an outer circumference to a central downcomer opening.

In addition to one or more of the features described above, or as an alternative, further embodiments could include pin-fin condenser with a plurality of uniform pin fins on a surface of the condenser, the uniform pin fins being configured to decrease a flow area of the condenser from an outer circumference to a central downcomer opening.

In addition to one or more of the features described above, or as an alternative, further embodiments could include a foam condenser with dissimilar pore structures that is configured to decrease a flow area of the condenser from an outer circumference to a central downcomer opening.

In addition to one or more of the features described above, or as an alternative, further embodiments could include a condenser that is configured to condense the vaporized working fluid through heat exchange with the substrate.

In addition to one or more of the features described above, or as an alternative, further embodiments could include a condenser that is configured to provide a higher velocity of the vaporized working fluid as it traverses radially through the condenser.

In addition to one or more of the features described above, or as an alternative, further embodiments could include a condenser that is configured to have a decreased flow area from an outer circumference to a central downcomer opening as a function of vaporized working fluid to condensed working fluid in a flow stream through the condenser.

According to another aspect of the invention, a method for cooling an inductor assembly includes circulating coolant through a substrate; and coupling the inductor assembly to the substrate; circulating working fluid through the inductor assembly; cooling a vaporized working fluid in the inductor assembly to form a condensed working fluid; and circulating the condensed working fluid through the inductor assembly through a thermosiphon effect.

In addition to one or more of the features described above, or as an alternative, further embodiments could include providing the inductor assembly having an outer cylindrical housing arranged on the substrate and defining an internal cavity; a wound inductor core arranged in internal cavity; a condenser arranged between the wound inductor core and the substrate; and a working fluid disposed in the internal cavity and in contact with each of the inductor core and the condenser.

In addition to one or more of the features described above, or as an alternative, further embodiments could include condensing the vaporized working fluid as it traverses through the condenser.

In addition to one or more of the features described above, or as an alternative, further embodiments could include decreasing a flow area of the condenser from an outer circumference to a central downcomer opening with an array of radial strip fins on a surface of the condenser.

In addition to one or more of the features described above, or as an alternative, further embodiments could include decreasing a flow area of the condenser from an outer circumference to a central downcomer opening with an array of radial strip fins on a surface of the condenser.

In addition to one or more of the features described above, or as an alternative, further embodiments could include decreasing a flow area of the condenser from an outer circumference to a central downcomer opening with a foam condenser having dissimilar pore structures.

In addition to one or more of the features described above, or as an alternative, further embodiments could include condensing the vaporized working fluid through heat exchange between the condenser and the substrate.

In addition to one or more of the features described above, or as an alternative, further embodiments could include providing a higher velocity of the vaporized working fluid with the condenser as it traverses radially through the condenser.

Technical function of one or more of the features described above include cooling toroid inductors by immersing the inductor in a dielectric working fluid and removing the heat by a thermosiphon effect using a condenser in thermal communication with a cold plate heat exchanger.

Other aspects, features, and techniques of the invention will become more apparent from the following description taken in conjunction with the drawings.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which like elements are numbered alike in the several FIGURES:

FIG. 1 is an immersion cooled toroid inductor assembly in accordance with an embodiment of the invention;

FIG. 2 is a perspective view of a core of the toroid inductor assembly of FIG. 1 but is shown without a bobbin in accordance with an embodiment of the invention;

FIG. 3 is a schematic cross-section view of a portion of the inductor assembly of FIG. 1 in accordance with an embodiment of the invention;

FIG. 4A illustrates a detailed top views of a winding bobbin in accordance with an embodiment of the invention;

FIG. 4B illustrates a detailed expanded view of a cooling passage of the winding bobbin of FIG. 4A in accordance with an embodiment of the invention; and

FIGS. 5A to 5C depict exemplary condensers in accordance with embodiments of the invention.

### DETAILED DESCRIPTION OF THE INVENTION

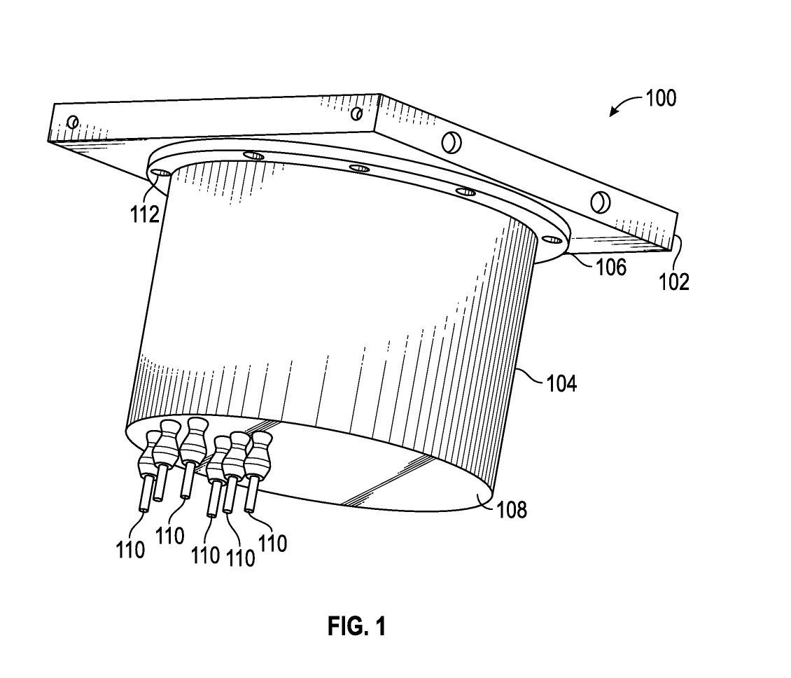

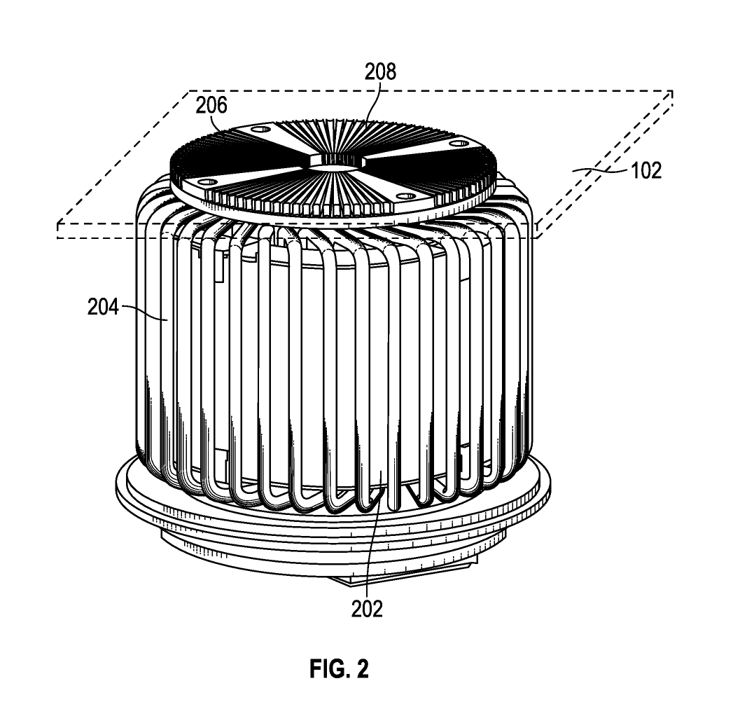

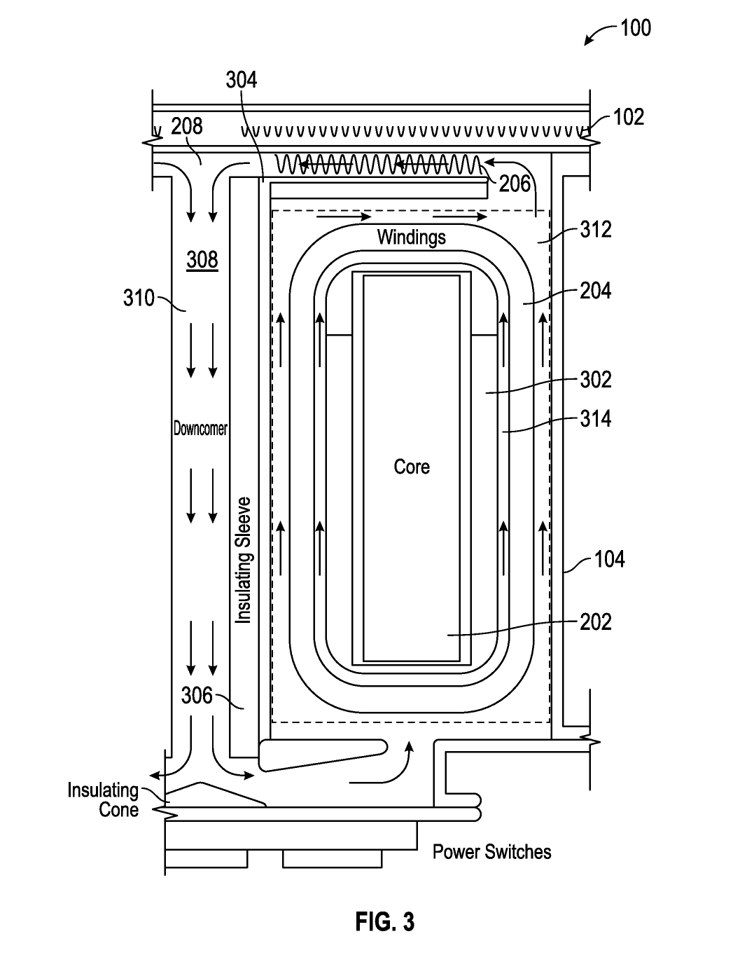

With reference to the figures, FIG. 1 depicts an example of an immersion cooled toroid inductor assembly 100 in accordance with an embodiment of the present invention. The inductor assembly 100 includes a substrate 102. The substrate 102 may be a cold plate, a heat dissipating substrate, for example, a plate-fin heat exchanger, or any other similar substrate with relatively low thermal resistance. Substrate 102 circulates coolant in order to spread and dissipate heat generated by inductor assembly 100. Inductor assembly 100 further includes an outer cylindrical housing 104 connected to substrate 102. The outer cylindrical housing 104 is generally cylindrical in shape and includes a circumferential flange 106 at a first end and a sealing cap 108 at a directionally opposite second end. Outer cylindrical housing 104 defines an internal cavity that receives, for example, an inductor core, inductor windings, bobbin, and condenser coil (shown in FIGS. 2 and 3). Flange 106 includes a plurality of through-holes 112 that are configured to receive fasteners (not shown) and seal the interior cavity of outer cylindrical housing 102 to substrate 102. The outer cylindrical housing 104 may be formed of any suitable material, including metal and/or plastic. Furthermore, outer cylindrical housing 104 may include a plurality of gasketed through-holes on an external surface of sealing cap 108 through which contacts 110 are attached. Contacts 110 provide electrical communication from an exterior of the inductor assembly 100 to inductor windings within the interior cavity of the outer cylindrical housing 104. The gasketed through-holes may include a through-hole, a sealing gasket, and/or a fastener configured to secure associated contacts 110 within the sealing gaskets. The internal cavity of outer cylindrical housing 104 may be filled with a working fluid, for example, a dielectric single-phase liquid coolant that circulates within the housing as a single phase flow and removes heat from the core.

FIG. 2 is a perspective view of a portion of inductor assembly 100 of FIG. 1 that is shown without an inductor winding bobbin and outer cylindrical housing 104 (FIG. 1) in accordance with an embodiment of the invention. Inductor assembly 100 includes an inductor core 202, inductor windings 204, and condenser 206. Inductor core 202 is configured to be arranged within an inductor winding bobbin (shown in FIG. 3), which secures and supports inductor windings 204 about inductor core 202. Inductor core 202 may be a ferromagnetic inductive core of a toroid shape and structure. A condenser 206 is coupled to inductor core 202 between inductor windings 204 and substrate 102 (shown in phantom). Substrate 102 includes an independent liquid cooling loop that circulates coolant through substrate 102. Condenser 206 is in thermal communication with substrate 102. Working fluid within internal cavity of outer cylindrical housing 104 (FIG. 1) is cooled by substrate 102 as working fluid traverses over condenser 206 from a radial external circumference to downcomer opening 208. In an embodiment, working fluid can be a liquid coolant that undergoes a phase transition in inductor assembly 100 such as, for example, perfluorohexane (C6F14) that is available as FLUORINERT™ (FC-72) from 3M™. Also, in embodiments, condenser 206 is a heat exchanger with heat exchange elements, for example, condenser 206 can be a plate-fin heat exchanger with a plurality of radial fins, a carbon foam heat exchanger, a pin-fin heat exchanger with a plurality of pin fins, or the like.

FIG. 2 depicts an exemplary inductor assembly 100 with a plate-fin heat exchanger. Condenser 206 of FIG. 2 has a plurality of radial fins that extend radially from a downcomer opening 208 to its circumference. Downcomer opening 208 is aligned along a central passage of core 202 and provides a return flow of condensed working fluid from condenser 206 to inductor core 202. Condenser 206 is configured to be in thermal contact with substrate 102 and transfers heat from the working fluid in inductor assembly 100 to substrate 102 as vaporized working fluid traverses through the channels in the radial fins of condenser 206. Heat transfer from the vaporized working fluid condenses and cools the working fluid. The cooled working fluid has a greater density and travels through downcomer opening 208 and through a central passage of core 202 to replace heated working fluid that travels upwards along riser passages in the inductor winding bobbin (not shown) through a thermosiphon effect, as will be described below in reference to FIG. 3.

FIG. 3 is a cut-away view of a portion of the inductor assembly 100. As shown, inductor assembly 100 further includes windings 204 that are wound about a winding bobbin 302. Windings 204 may be conductive windings configured to transmit electricity about and around an inductor core 202. Inductor assembly 100 includes an inner cylindrical housing 304 arranged within winding bobbin 302. An insulating sleeve 306 surrounds inner cylindrical housing 304 to electrically insulate housing 304 from windings 204. A condenser 206 is arranged on inner cylindrical housing 304 and is in thermal contact with core 102. Condenser 206, in embodiments, may be a plate fin condenser, a corrugated condenser, a pin fin condenser, a radial fin condenser, a carbon foam condenser, or any other suitable condenser with a radially inward flow pattern that has decreasing a flow area with flow length and being configured to cool vaporized working fluid as it traverses through condenser 206. As such, as vaporized working fluid flows over and through condenser, the vaporized working fluid condenses. The property of decreasing flow area with flow length provides several heat transfer benefits in condensation. First, a condensing flow will have a reducing volumetric flow rate which is better matched by the flow area schedule for radially inward flows. This shear flow arrangement keeps velocities high; thinning condensate films and increasing heat transfer coefficients. The higher velocities mitigate back diffusion on non-condensable gases, which could reduce condensation rates. Also the non-condensable gases are swept to downcomer passage 308 from downcomer opening 208 for easy venting. The shear flow arrangement is inherently more stable because the pressure drops are high than straight flow designs which have significant pressure recovery from velocity.

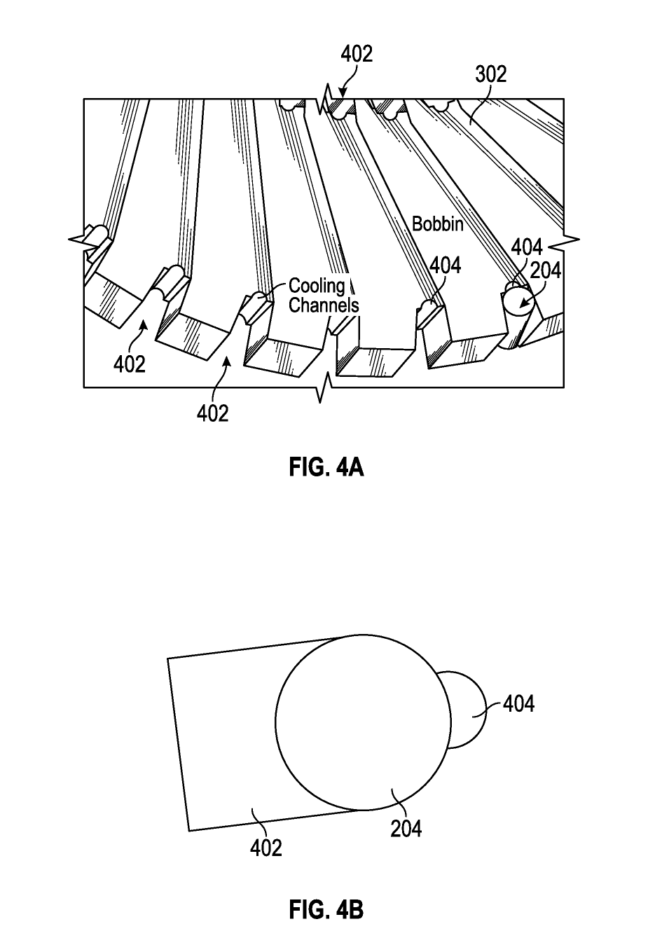

Also, outer cylindrical housing 104 and therefore at least a portion of the inductor assembly 100 may be filled with a working fluid. Thus, inductor core 202 and windings 302 may be exposed to the working fluid. During operation, heat generated at core 202 and windings 302 may introduce a thermal gradient which causes working fluid to flow. With modest heat fluxes, the working fluid will circulate as a single phase liquid, carrying heat away from components that are dissipating heat. At high heat fluxes, the working fluid will flow as a two-phase fluid by boiling. Thus, as flow is introduced between differing temperatures to affect equalization, and overall fluid flow path is created through the inner cylindrical cavity 310, over and through inductor core 202 and windings 204, through path 312, and over and through condenser 206. The heat in fluid flow path is removed by condenser 206. The other side of this condenser is cooled by substrate 102. Flow of working fluid is naturally pumped by a thermosiphon effect wherein fluid flow is upward through flow channels 314 between winding bobbin 302 and windings 204, and path 312 where heat is added (i.e., around windings 204 or inductor core 202) to boil and/or vaporize working fluid and downward as liquid flow in inner cylindrical cavity 310 in a region where the cooled working fluid can descend from condenser 206. FIGS. 4A and 4B illustrate examples of flow passages for flow of working fluid in inductor assembly 100. FIGS. 4A and 4B depict only one winding 204 for clarity. Fluid circulation is driven by the density difference of the two-phase mixture in the heated channels (riser passages) to the all liquid density in the liquid downcomer channels or passages 308.

As shown in FIG. 4A, winding 204 is secured and supported by winding bobbin 302 such that working fluid flow is not inhibited. As shown in FIGS. 4A and 4B, winding bobbin 302 includes a plurality of axial supported flow channel 402 arranged on an outer circumference and an inner circumference of winding bobbin 302. Each axial supported flow channel 402 includes a semi-circular cooling inner channel 404 immediately proximate winding 204 and configured to allow working fluid to flow therein.

Referring back to FIG. 3, with continued reference to FIGS. 4A and 4B, winding 204 winding is exposed to flow in two channels 402 and 404. At higher heat fluxes, boiling or evaporation will occur on the heat dissipation surfaces, e.g., inductor core 202 with the latent heat of phase change providing the cooling effect. The vapor that is generated, normally in bubbles or slugs is carried by fluid convection and buoyancy along path 312 to condenser 206 where the heat of vaporization is removed and the fluid returns to a liquid state. Under some conditions of operation, boiling may occur with the generated bubbles being condensed in condenser 206 through heat exchange with a circulating and subcooled fluid coolant in substrate 102. It shall be understood that the term “fluid” herein shall refer to a material that is in a liquid state (single-phase), a vaporized state (e.g., a gas) or any combination thereof.

In high heat flux operation, as the density of the heated or bubbly working fluid in the channels 402 and 404 is less than the cold or condensed working fluid from condenser 206, the cooler, more dense working fluid in downcomer passage 308 travels downward in inner cylindrical cavity 310 and replaces the heated or bubbly working fluid going into channels 402 and 404 through a thermosiphon effect. Circulating the cooled working fluid through inductor core 202 cools it to a temperature close to the substrate 102 temperature instead of operating near the winding 204 temperature. In low power operation or with low working fluid temperatures, the flow of working fluid in inductor assembly 100 is driven by natural convection. The flow pattern is the same as with boiling, but the velocities are smaller because they are driven by the cold-to-hot fluid density variation. The design of condenser 206 is optimized with a radially inward flow pattern in order to create high velocities of vaporized working fluid as it travels through condenser 206. A shear flow condenser 206 can be achieved by sizing vertical and horizontal features for the condenser 206. In condenser 206, flow area of the heat exchange elements decreases with the flow length and quality (fraction of vapor in the condensing flow) from outer circumference to downcomer opening 208. With this condenser design, the flow velocity is kept high, which provides three benefits: 1) the heat transfer coefficients are high because the condensing film thickness is thinned by the shear force, 2) non-condensable gases are swept along the flow length, reducing the mass diffusion blanket effect which reduces the condensation rate, and 3) the condenser operation is more stable. Additionally, instabilities such as run-back and liquid leg are mitigated by having a positive pressure gradient between input and output of condenser 206.

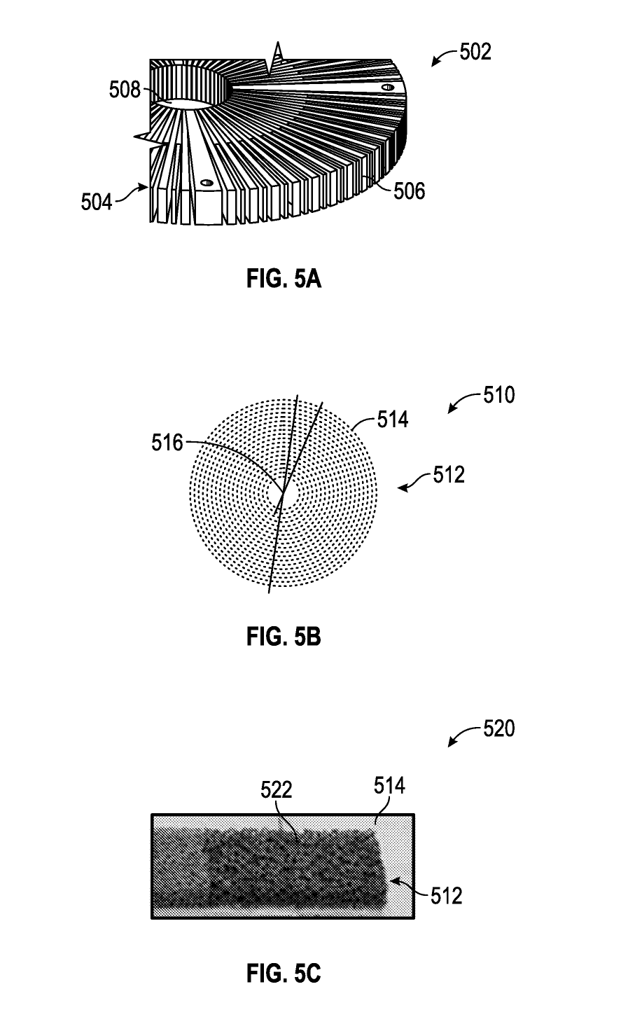

FIGS. 5A to 5C depict exemplary condensers for use in accordance with embodiments of the invention. For example, as shown in FIG. 5A, condenser 502 is a plate-fin condenser that includes an array of radial strip fins 504 arranged radially. Also, in embodiment, the number of fins 504 can be decreased or the thickness of the fins 504 can be decreased in the radial flow direction from outer circumference 506 to downcomer opening 508 in order to decrease the flow area of condenser 502. Particularly, the flow area of the condenser 502 decreases with the flow length and fraction of vapor in the condensing flow from outer circumference 506 to downcomer opening 508. FIG. 5B depicts a pin fin condenser 510 with a plurality of pin-fins 512 arranged on the surface of condenser 510. The spacing of pin fins can be kept uniform which decreases flow area from outer circumference 514 to downcomer opening 516. The flow area of the condenser 510 decreases with the flow length and fraction of vapor in the condensing flow from outer circumference 514 to downcomer opening 516. Alternatively, non-uniform pin fin spacing can be implemented with greater number of pin fins on an outer circumference of condenser 510, and progressively getting less as we move towards the center of condenser 510. FIG. 5C depicts a foam condenser 520 with a graphite or metal foam condensing surface 522. In embodiments, different pore structures for different radial positions could be used to control the velocity profile of vaporized working fluid through the condenser 520. In an example, a higher density foam structure can be used at the circumference of condenser 520 and lower density foam structure can be used at the downcomer opening. The flow area of condenser decreases with the flow length and fraction of vapor in the condensing flow from outer circumference to downcomer opening.

Embodiments of the invention disclosed herein for application provide benefits over prior art inductors. For example, the immersion cooled toroid inductor assembly of the embodiments described above will operate much cooler than with conventional cooling. The inductor core temperature can be made close to the cold plate temperature instead of operating near the winding temperature through use of a condenser that circulates working fluids through a thermosiphon effect. The immersion cooled inductor can be lighter than the conventional design. Because of this better cooling, the immersion cooled toroid inductor assembly can operate in harsher environments. The effective thermal inertia of the inductor is much larger because the circulating fluid shares heat between the windings, core, housing, and condenser. Wire or core heating therefore does not stay isolated which causes a higher temperature rise. The temperature rise of inductor components is much lower in loss of cooling (LOC) or in overload events. The inductors are contained in a clean and thermally controlled environment which should improve inductor life.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions or equivalent arrangements not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An inductor assembly, comprising:
a substrate that is configured to circulate coolant;
an outer cylindrical housing arranged on the substrate and defining an internal cavity;
a wound inductor core arranged in internal cavity;
a condenser arranged between the wound inductor core and the substrate; and
a working fluid disposed in the internal cavity and in contact with each of the inductor core and the condenser;
wherein the condenser is configured to condense vaporized working fluid as it traverses through the condenser.

2. The inductor assembly of claim 1, wherein the condenser is a plate-fin condenser with an array of radial strip fins that is configured to decrease a flow area of the condenser from an outer circumference to a central downcomer opening.

3. The inductor assembly of claim 1, wherein the condenser is a pin-fin condenser with a plurality of uniform pin fins on a surface of the condenser, the uniform pin fins being configured to decrease a flow area of the condenser from an outer circumference to a central downcomer opening.

4. The inductor assembly of claim 1, wherein the condenser is a foam condenser with dissimilar pore structures that is configured to decrease a flow area of the condenser from an outer circumference to a central downcomer opening.

5. The inductor assembly of claim 1, wherein the condenser is configured to condense the vaporized working fluid through heat exchange with the substrate.

6. The inductor assembly of claim 1, wherein the condenser is configured to provide a higher velocity of the vaporized working fluid as it traverses radially through the condenser.

7. The inductor assembly of claim 1, wherein the condenser is configured to have a decreased flow area from an outer circumference to a central downcomer opening as a function of vaporized working fluid to condensed working fluid in a flow stream through the condenser.

8. A method for cooling an inductor assembly, comprising:
circulating coolant through a substrate;
coupling the inductor assembly to the substrate;
circulating working fluid through the inductor assembly;
cooling a vaporized working fluid in the inductor assembly to form a condensed working fluid; and
circulating the condensed working fluid through the inductor assembly through a thermosiphon effect.

9. The method of claim 8, wherein the coupling of the inductor assembly to the substrate further comprises providing the inductor assembly including:
an outer cylindrical housing arranged on the substrate and defining an internal cavity;
a wound inductor core arranged in internal cavity;
a condenser arranged between the wound inductor core and the substrate; and
a working fluid disposed in the internal cavity and in contact with each of the inductor core and the condenser.

10. The method of claim 9, further comprising condensing the vaporized working fluid as it traverses through the condenser.

11. The method of claim 9, further comprising decreasing a flow area of the condenser from an outer circumference to a central downcomer opening with an array of radial strip fins on a surface of the condenser.

12. The method of claim 9, further comprising decreasing a flow area of the condenser from an outer circumference to a central downcomer opening with an array of radial strip fins on a surface of the condenser.

13. The method of claim 9, further comprising decreasing a flow area of the condenser from an outer circumference to a central downcomer opening with a foam condenser having dissimilar pore structures.

14. The method of claim 9, further comprising condensing the vaporized working fluid through heat exchange between the condenser and the substrate.

15. The method of claim 9, further comprising providing a higher velocity of the vaporized working fluid with the condenser as it traverses radially through the condenser.
